(19) United States
(12) Patent Application Publication
(10) Pub. No.: US 2011/0242705 A1
(43) Pub. Date: Oct. 6, 2011

(54) MAGNETIC HEAD, MAGNETIC HEAD ASSEMBLY, AND MAGNETIC RECORDING/REPRODUCING APPARATUS

(75) Inventors: Masayuki TAKAGISHI, Tokyo (JP); Kenichiro Yamada, Tokyo (JP); Hitoshi Iwasaki, Tokyo (JP)

(73) Assignee: Kabushiki Kaisha Toshiba, Tokyo (JP)

(21) Appl. No.: 12/881,555

(22) Filed: Sep. 14, 2010

(30) Foreign Application Priority Data
Mar. 31, 2010 (JP) 2010-082958

(51) Int. Cl. G11B 5/127; G11B 5/48

(52) U.S. Cl. 360/246.1; 360/319; G9B/5.04; G9B/5.147

(57) ABSTRACT

According to one embodiment, a magnetic head includes a reproducing section. The reproducing section includes a first magnetic shield, a second magnetic shield, a magnetoresistive effect film, and a third magnetic shield. The magnetoresistive effect film is provided between the first magnetic shield and the second magnetic shield and includes a first magnetization free layer changing a magnetization direction in response to an external magnetic field. The third magnetic shield is provided between the magnetoresistive effect film and the first magnetic shield and has a higher saturation magnetic flux density than the first magnetic shield.

### CROSS-REFERENCE TO RELATED APPLICATIONS

This application is based upon and claims the benefit of priority from the prior Japanese Patent Application No. 2010-082958, filed on Mar. 31, 2010; the entire contents of which are incorporated herein by reference.

### FIELD

Embodiments described herein relate generally to a magnetic head, a magnetic head assembly, and a magnetic recording/reproducing apparatus.

### BACKGROUND

Signal reproduction in current HDD (hard disk drive) uses a TMR (tunneling magnetoresistive) head, which passes current in the perpendicular-to-plane direction. With the increase of recording density in the future, miniaturization of the reproducing device is required. Thus, a magnetoresistive effect device with lower resistance per unit cross-sectional area is needed.

On the other hand, in a device as small as 20 nanometers (nm) square, it is known that magnetic noise due to spin transfer torque is more likely to occur even at low current (see, e.g., K. Yamada et al: INTERMAG2008, Digest, GB-07).

Thus, methods are under study for suppressing noise due to spin transfer torque by designing a suitable composition of the magnetoresistive effect film (see, e.g., S. Maat, N. Smith, M. J. Carey, and J. R. Childress: APPLIED PHYSICS LETTERS 93, 103506 (2008) and M. J. Carey et al: APPLIED PHYSICS .LETTERS 93, 102509 (2008)). In another proposal, the magnetoresistive effect film includes a structure with a pair of magnetization free layers opposed across an intermediate layer (see, e.g., R. Lamberton et al: IEEE Trans, Magn., vol 43, (2007) p645). However, in these techniques, there is concern about the degradation of reproducing resolution due to the decreased MR ratio and the increased film thickness of the magnetoresistive effect film.

### BRIEF DESCRIPTION OF THE DRAWINGS

FIG. 1 is a schematic view illustrating a magnetic head;

FIG. 2 is a schematic perspective view illustrating the magnetic head;

FIG. 3 is a schematic perspective view illustrating part of a magnetic recording/reproducing apparatus;

FIG. 4 is a schematic view illustrating a magnetic head according to a comparative example;

FIG. 5 is a diagram illustrating the characteristics of the magnetic head;

FIG. 6 and FIG. 7 are diagrams illustrating the characteristics of the magnetic head;

FIG. 8A and FIG. 8B are schematic view illustrating a magnetic head;

FIG. 9 is a schematic perspective view illustrating the configuration of a magnetic recording/reproducing apparatus; and

FIGS. 10A and 10B are schematic perspective view illustrating part of a magnetic recording/reproducing apparatus.

### DETAILED DESCRIPTION

In general, according to one embodiment, a magnetic head includes a reproducing section. The reproducing section includes a first magnetic shield, a second magnetic shield, a magnetoresistive effect film, and a third magnetic shield. The magnetoresistive effect film is provided between the first magnetic shield and the second magnetic shield and includes a first magnetization free layer changing a magnetization direction in response to an external magnetic field. The third magnetic shield is provided between the magnetoresistive effect film and the first magnetic shield and has a higher saturation magnetic flux density than the first magnetic shield.

According to another embodiment, a magnetic head assembly includes a suspension and an actuator arm. The suspension is configured to install the magnetic head on one end. The actuator arm is connected to one other end of the suspension.

According to yet another embodiment, a magnetic recording/reproducing apparatus includes the magnetic head assembly and a magnetic recording medium. The magnetic recording medium has information to be reproduced by using the magnetic head installed on the magnetic head assembly.

Embodiments of the invention will now be described with reference to the drawings.

The drawings are schematic or conceptual. The relationship between the thickness and the width of each portion, and the size ratio between the portions, for instance, are not necessarily identical to those in reality. Furthermore, the same portion may be shown with different dimensions or ratios depending on the figures.

In the specification and the drawings, the same components as those described previously with reference to earlier figures are labeled with like reference numerals, and the detailed description thereof is omitted as appropriate.

### FIRST EMBODIMENT

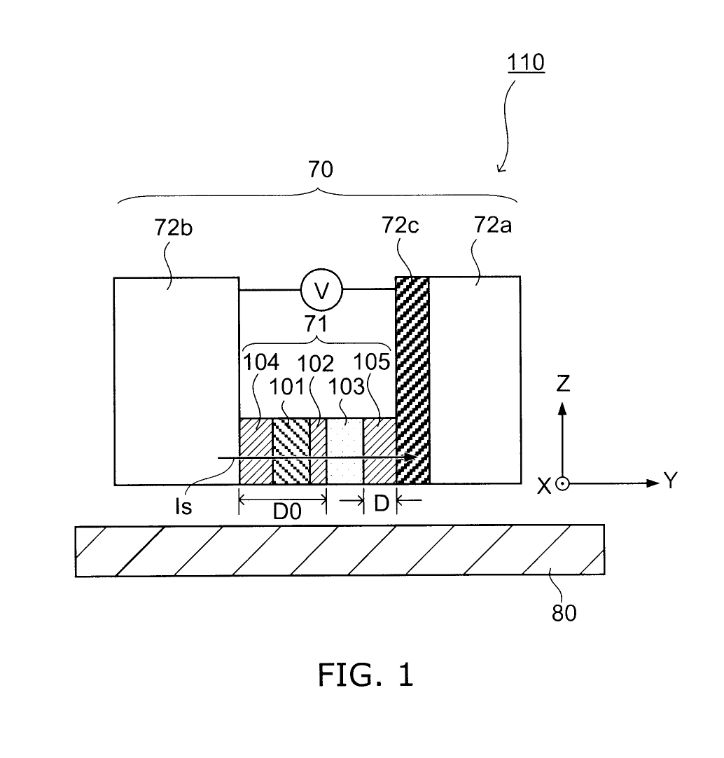

FIG. 1 is a schematic view illustrating the configuration of a magnetic head according to a first embodiment.

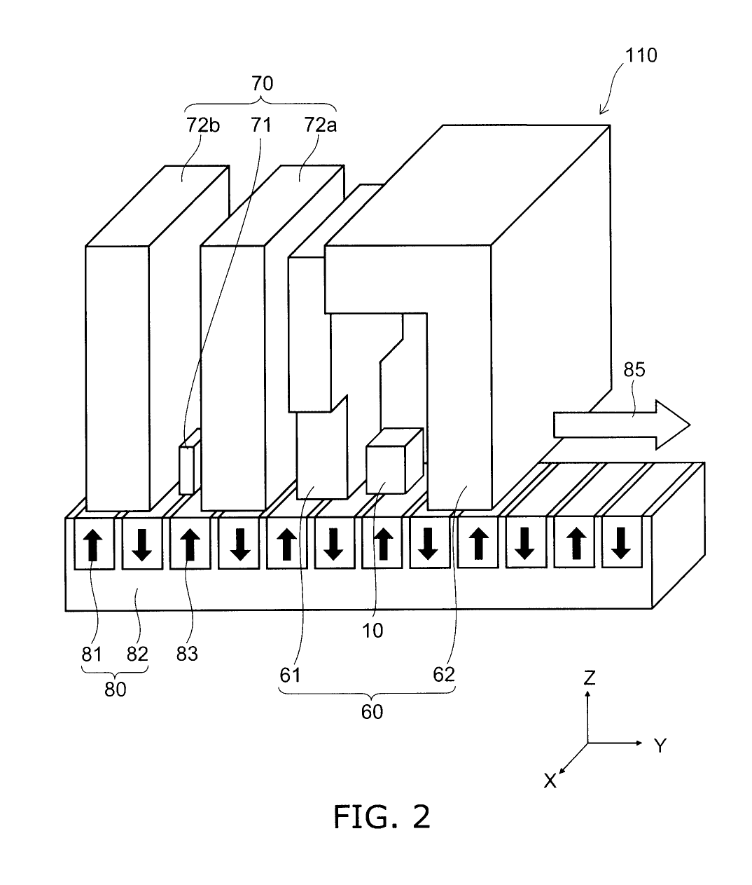

FIG. 2 is a schematic perspective view illustrating the configuration of the magnetic head according to the first embodiment.

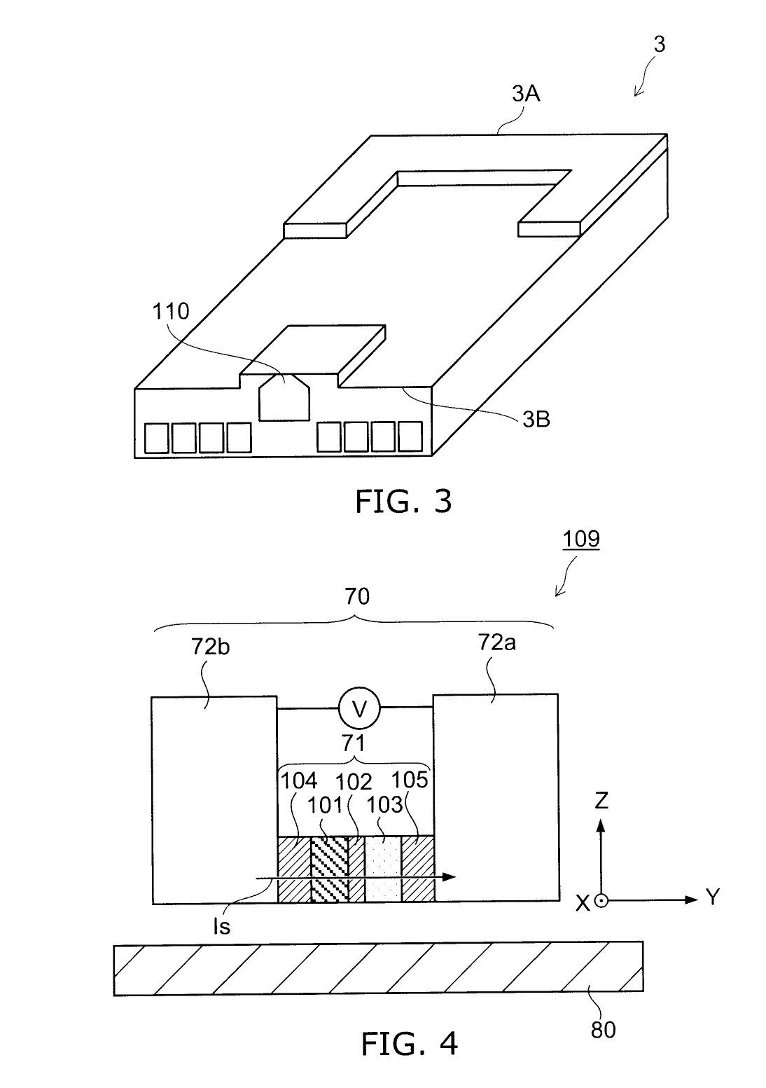

FIG. 3 is a schematic perspective view illustrating the configuration of a head slider installing the magnetic head according to the first embodiment.

First, the overview and operation of the magnetic head according to this embodiment are described with reference to FIGS. 2 and 3.

As shown in FIG. 2, the magnetic head 110 includes a reproducing head section (reproducing section) 70. Furthermore, the magnetic head 110 includes a writing head section 60.

The writing head section 60 includes a main magnetic pole 61, a return path (shield) 62, and a spin torque oscillator (stacked structure). The spin torque oscillator 10 is provided between the main magnetic pole 61 and the return path 62. Here, in the magnetic head 110 according to this embodiment, the writing head section 60 may be other than that using the spin torque oscillator 10. That is, the magnetic head 110 can be based on any recording scheme.

The reproducing head section 70 includes a magnetoresistive effect film 71, a first magnetic shield 72a, and a second magnetic shield 72b. The magnetoresistive effect film 71 is provided between the first magnetic shield 72a and the second magnetic shield 72b.

The components of the aforementioned reproducing head section 70 and the components of the aforementioned writing head section 60 are isolated from each other by e.g. alumina insulator, not shown.

The magnetoresistive effect film 71 can be a GMR device, TMR device, or CCP (current-confined-path) CPP (current perpendicular to plane)-GMR device.

As shown in FIG. 3, the magnetic head 110 is installed on a head slider 3. The head slider 3 is illustratively made of Al₂O₃/TiC. The head slider 3 is designed and manufactured so as to be able to relatively move on a magnetic recording medium 80 such as a magnetic disk while floating thereabove or being in contact therewith.

The head slider 3 has an air inflow side 3A and an air outflow side 3B. The magnetic head 110 is located on the side surface of the air outflow side 3B, for instance. Thus, the magnetic head 110 installed on the head slider 3 relatively moves on the magnetic recording medium 80 while floating thereabove or being in contact therewith.

As shown in FIG. 2, the magnetic recording medium 80 illustratively includes a medium substrate 82 and a magnetic recording layer 81 provided thereon. The magnetization 83 of the magnetic recording layer 81 is controlled to a prescribed direction by the magnetic field applied from the writing head section 60, and thereby writing is performed. Here, the magnetic recording medium 80 moves relative to the magnetic head 110 in the medium moving direction 85. On the other hand, the reproducing head section 70 reads the direction of magnetization of the magnetic recording layer 81.

Next, the configuration of the reproducing head section 70 is described.

FIG. 1 is a schematic sectional view of the reproducing head section 70.

The reproducing head section 70 is opposed to the magnetic recording medium 80. Here, in FIG. 1, the stacking direction of the magnetoresistive effect film 71 is defined as direction Y. Of the directions perpendicular to the direction Y, the direction perpendicular to the plane of the magnetoresistive effect film 71 opposed to the magnetic recording medium 80 is defined as direction Z. The direction perpendicular to the directions Y and Z is defined as direction X. FIG. 1 shows a cross section taken along the Y-Z plane. It is assumed that the direction Y is matched with the recording down track direction.

Although not shown in FIG. 1, the reproducing head section 70 is provided with a writing head section 60.

The reproducing head section 70 reads the change of resistance based on the direction of magnetization recorded on the magnetic recording medium 80. More specifically, a sense current Is is passed in a direction (direction Y) nearly perpendicular to the film plane of the magnetoresistive effect film 71. The change of resistance corresponding to the direction of magnetization recorded on the magnetic recording medium 80 is detected as the change of the sense current Is.

The reproducing head section 70 includes a magnetoresistive effect film 71 including a first magnetization free layer 103, a first magnetic shield 72a located on one side of the magnetoresistive effect film 71, a second magnetic shield 72b located on the other side of the magnetoresistive effect film 71, and a third magnetic shield 72c located between the magnetoresistive effect film 71 and the first magnetic shield 72a.

The width (length along the direction X) of the magnetoresistive effect film 71 is comparable to or less than the recording track width. In the magnetoresistive effect film 71, a current (sense current Is) is passed in the perpendicular-to-plane direction of the magnetoresistive effect film 71 through the first magnetic shield 72a and the second magnetic shield 72b.

The magnetoresistive effect film 71 illustratively includes a underlayer 104, a magnetization pinned layer 101, an intermediate layer 102, a first magnetization free layer 103, and a cap layer 105. The magnetoresistive effect film 71 is stacked along the direction Y in the order of, e.g., the underlayer 104, magnetization pinned layer 101, intermediate layer 102, first magnetization free layer 103, and cap layer 105.

That is, the magnetoresistive effect film 71 further includes a magnetization pinned layer 101 opposed to the first magnetization free layer 103 along the stacking direction from the first magnetic shield 72a to the second magnetic shield 72b, and an intermediate layer 102 provided between the magnetization pinned layer 101 and the first magnetization free layer 103.

Here, the underlayer 104 is illustratively made of Ta, Ru, Pt, or Cu. The magnetization pinned layer 101 is illustratively based on a four-layer configuration including an antiferromagnetic film, a magnetic layer (e.g., FeCo alloy), an antiferromagnetic coupling film (e.g., Ru), and a magnetic layer (e.g., FeCo alloy or FeCoB alloy).

The intermediate layer 102 is illustratively made of a metal layer of e.g. Cu, a conductive layer embedded in an insulating layer, or an insulating layer of e.g. MgO.

The first magnetization free layer 103 is a layer (free layer) whose magnetization direction changes with the external magnetic field. The first magnetization free layer 103 is illustratively made of NiFe alloy, FeCo alloy, or FeCoB alloy. The cap layer 105 is illustratively made of Ru, Cu, or Pt.

The first magnetic shield 72a and the second magnetic shield 72b are illustratively made of NiFe alloy. The first magnetic shield 72a and the second magnetic shield 72b sandwich the magnetoresistive effect film 71 therebetween. In the magnetic head 110 according to this embodiment, a third magnetic shield 72c is provided between the magnetoresistive effect film 71 and the first magnetic shield 72a in the reproducing head section 70. That is, the magnetic shield provided on one side of the magnetoresistive effect film 71 has a stacked structure including the first magnetic shield 72a and the third magnetic shield 72c.

In this stacked structure, the spacing between the first magnetization free layer 103 and the third magnetic shield 72c is narrower than the spacing between the magnetization free layer 103 and the second magnetic shield 72b.

That is, the spacing D between the surface of the magnetization free layer 103 opposed to the third magnetic shield 72c and the surface of the third magnetic shield 72c opposed to the magnetization free layer 103 is narrower than the spacing D0 between the surface of the first magnetization free layer 103 opposed to the second magnetic shield 72b and the surface of the second magnetic shield 72b opposed to the first magnetization free layer 103.

Here, the third magnetic shield 72c has a higher saturation magnetic flux density than the first magnetic shield 72a. The third magnetic shield 72c is illustratively made of Fe, Co, Fe alloy, or Co alloy. The third magnetic shield 72c may be added with a non-magnetic element (such as N, C, Zr, Nb, B, Si, Al, and Ge) to improve soft magnetism.

Here, after the magnetoresistive effect film 71 is patterned into a fine feature, a foundation layer (not shown) for improving crystallinity may be provided between the third magnetic shield 72c and the cap layer 105. This foundation layer has an area different from that of the cap layer 105 in the X-Z plane.

This foundation layer can illustratively be made of a non-magnetic material, or a magnetic material having a lower saturation magnetic flux density than the third magnetic shield 72c.

Furthermore, in the third magnetic shield 72c, a layer of e.g. Ru, Rh, or Ir having a thickness of approximately 1 nanometer (nm) or less may be inserted to remove unstable magnetic domains in the third magnetic shield 72c. In the third magnetic shield 72c with the above layer inserted therein, the shield materials opposed across this layer are strongly and antiferromagnetically coupled to each other, and hence are more likely to form single magnetic domains.

The size of the surface (the area of the X-Z plane) of the third magnetic shield 72c facing the first magnetization free layer 103 is larger than the size of the surface (the area of the X-Z plane) of the first magnetization free layer 103 facing the third magnetic shield 72c. For instance, the third magnetic shield 72c is stacked with a size nearly equal to the size of the surface of the first magnetic shield 72a facing the magnetoresistive effect film 71.

### COMPARATIVE EXAMPLE

Here, a comparative example is described. FIG. 4 is a schematic view illustrating the configuration of a magnetic head according to the comparative example.

FIG. 4, just like FIG. 1, shows a cross section along the Y-Z plane of the reproducing head section 70 opposed to the magnetic recording medium 80.

The magnetic head 109 according to the comparative example includes a magnetoresistive effect film 71 including a first magnetization free layer 103, a first magnetic shield 72a located on one side of the magnetoresistive effect film 71, and a second magnetic shield 72b located on the other side of the magnetoresistive effect film 71.

The magnetoresistive effect film 71 includes a underlayer 104, a magnetization pinned layer 101, an intermediate layer 102, a first magnetization free layer 103, and a cap layer 105.

In the magnetic head 109 thus configured, methods for suppressing spin transfer torque have been considered, such as the method of stacking a layer containing a rare earth element on the first magnetization free layer 103, and the method of stacking a Ru layer and a magnetic layer thereon. However, the method of stacking a layer containing a rare earth element on the first magnetization free layer 103 results in decreased MR ratio and decreased corrosion resistance. In the method of stacking a Ru layer and a magnetic layer on the first magnetization free layer 103, the film thickness of the magnetoresistive effect film 71 increases, which results in the increase of reproduction gap length.

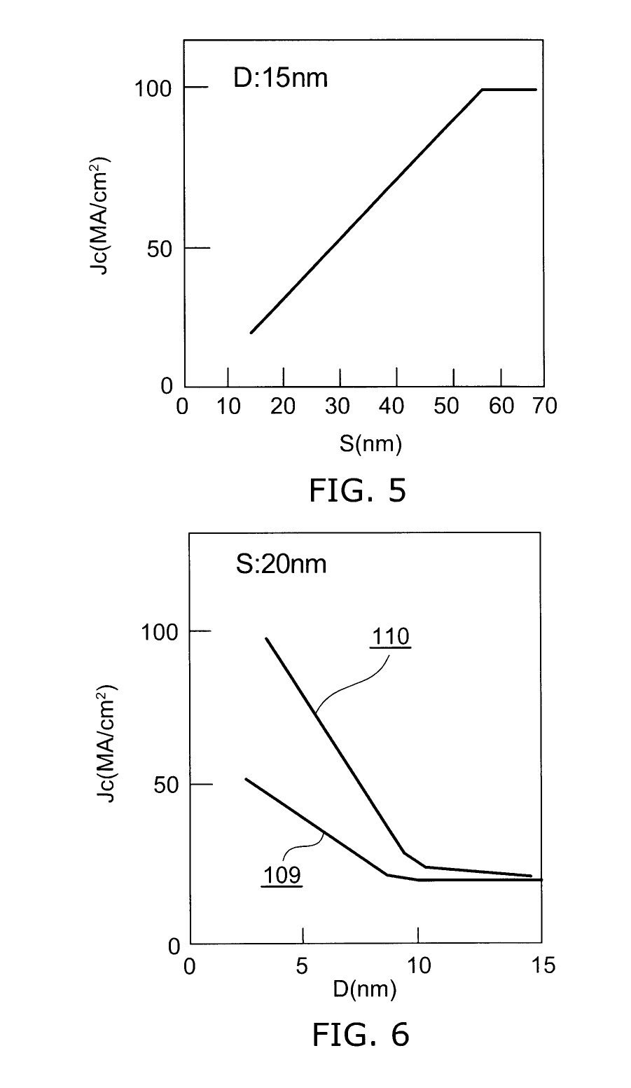

FIG. 5 is a graph illustrating the characteristics of the magnetic head.

More specifically, FIG. 5 shows the relationship between the size S of the magnetization free layer in the magnetic head and the critical current density Jc (MA/cm²) at which noise increases due to spin transfer torque.

Here, the size S of the magnetization free layer refers to the length of one side assuming that the shape of the current-flow cross section is a square. The characteristics shown in FIG. 5 are the result of calculating the generated spin transfer torque by micromagnetic simulation in the case where the spacing D is 15 nanometers (nm).

As shown in FIG. 5, if the size S of the magnetization free layer falls below approximately 50 nanometers (nm), the critical current density Jc at which noise increases due to spin transfer torque sharply decreases. This makes it difficult for the information recorded on the magnetic recording medium to be reproduced with high sensitivity.

Here, in high density reproduction at 1 terabit or more per square inch, the recording track width is 30 nanometers (nm) or less. Hence, the width of the magnetization free layer (corresponding to the size of the magnetization free layer) also needs to be generally at the same level, i.e., 30 nanometers (nm) or less. For such thickness of the magnetization free layer, the magnetic head 109 is significantly affected by noise due to spin transfer torque.

FIG. 6 is a graph illustrating the characteristics of the magnetic head.

More specifically, this figure shows an example of the shield effect in the magnetic heads 110 and 109, and illustrates the relationship between spacing D and critical current density Jc.

The characteristics shown in FIG. 6 are the result of calculating the relationship between spacing D and critical current density Jc by micromagnetic simulation. As in FIG. 5, the critical current density Jc is the critical current density Jc (MA/cm²) at which noise increases due to spin transfer torque. The size S of the magnetization free layer is 20 nanometers (nm).

In FIG. 6, the relationship between spacing D and critical current density Jc is shown for each of the magnetic head 110 according to the first embodiment shown in FIG. 1 and the magnetic head 109 according to the comparative example shown in FIG. 4. In the simulation result for the magnetic head 110, the third magnetic shield 72c is made of FeCo alloy. In the simulation result for the magnetic head 109, the third magnetic shield 72c as in the magnetic head 110 is not provided.

As shown in FIG. 6, at spacings D equal to or less than 10 nanometers (nm) required for high density reproduction at 1 terabit or more per square inch, the simulation result exhibits a significant difference between the magnetic heads 110 and 109.

That is, the magnetic head 110 has a higher critical current density Jc than the magnetic head 109 at spacings D in the region of 10 nanometers (nm) or less.

Thus, the magnetic head 110 with a spacing D of 10 nanometers (nm) or less achieves a significant effect of suppressing spin transfer torque by the third magnetic shield 72c, and can ensure a high critical current density Jc. Consequently, the medium information can be reproduced with high sensitivity even if the recording track width is narrowed.

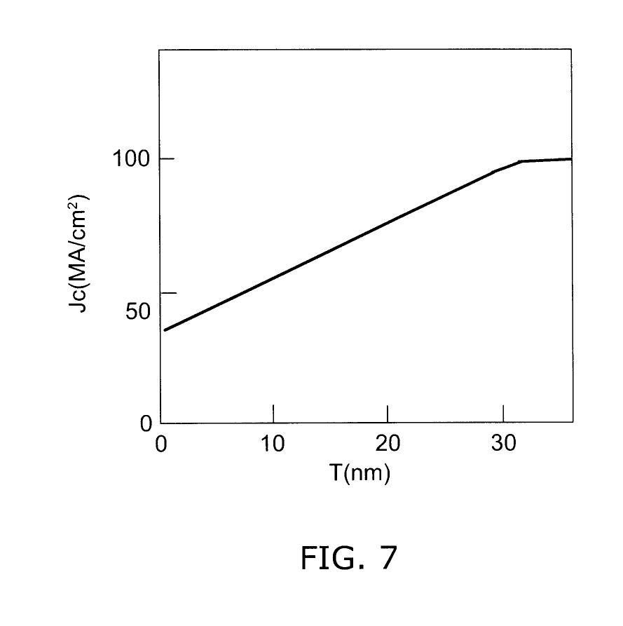

FIG. 7 is a graph illustrating the characteristics of the magnetic head.

More specifically, this figure illustrates the characteristics of the third magnetic shield 72c, and illustrates the relationship between the thickness T of the third magnetic shield 72c along the direction to the first magnetization free layer 103 and the critical current density Jc.

The characteristics shown in FIG. 7 are the result of calculating the relationship between the thickness T of the third magnetic shield and the critical current density Jc by micromagnetic simulation.

As shown in FIG. 7, as the thickness T of the third magnetic shield 72c increases, the spin transfer torque is suppressed, and the critical current density Jc increases.

However, if the thickness T of the third magnetic shield 72c is approximately 30 nanometers (nm) or more, the increase of critical current density Jc is generally saturated.

Here, the first magnetic shield 72a formed from NiFe alloy is superior in soft magnetism to FeCo alloy. Thus, the first magnetic shield 72a formed from NiFe alloy is assigned a major shielding function. On the other hand, the third magnetic shield 72c formed from FeCo alloy is assigned the role of suppressing spin transfer torque besides a shielding function. Thus, the third magnetic shield 72c is stacked with the first magnetic shield 72a. The third magnetic shield 72c has a smaller thickness than the first magnetic shield 72a. Preferably, for instance, the thickness of the third magnetic shield 72c is 30 nanometers (nm) or less where the critical current density Jc is saturated.

For instance, it is anticipated that realization of an area recording density of 2 terabits per square inch area (2 Tb/in²) requires a reproducing device having a current-flow cross-sectional area of approximately 20 nanometers (nm) square. This requires an area resistance (RA, current-flow cross-sectional area x resistance) of around 0.3 Ωμm² or less.

In the magnetic head 110 according to the first embodiment, magnetic noise due to spin transfer torque is suppressed while maintaining the area resistance RA of the magnetoresistive effect film 71. In particular, at a high recording density of 1 terabit or more per square inch, the recording track width is 30 nanometers (nm) or less, where the spin transfer torque significantly increases. However, the magnetic head 110 achieves magnetic noise reduction in a magnetic recording/reproducing apparatus with this high recording density. Thus, high-quality reproduced signals with high SN ratio are obtained.

Furthermore, because the third magnetic shield 72c is provided on the first magnetic shield 72a side, the third magnetic shield 72c does not affect the thickness of the magnetoresistive effect film 71. Hence, the third magnetic shield 72c does not affect the MR ratio of the magnetoresistive effect film 71, either.

In the example of the magnetic head 110 shown in FIG. 1, the third magnetic shield 72c is provided on the first magnetic shield 72a. However, the third magnetic shield 72c may be provided on the second magnetic shield 72b. In this case, the third magnetic shield 72c is provided between the underlayer 104 and the second magnetic shield 72b. Furthermore, the third magnetic shield 72c may be provided on both the first magnetic shield 72a and the second magnetic shield 72b.

### SECOND EMBODIMENT

Next, a magnetic head according to a second embodiment is described. Here, the magnetic head is described with focus on differences from the magnetic head 110 according to the first embodiment shown in FIG. 1.

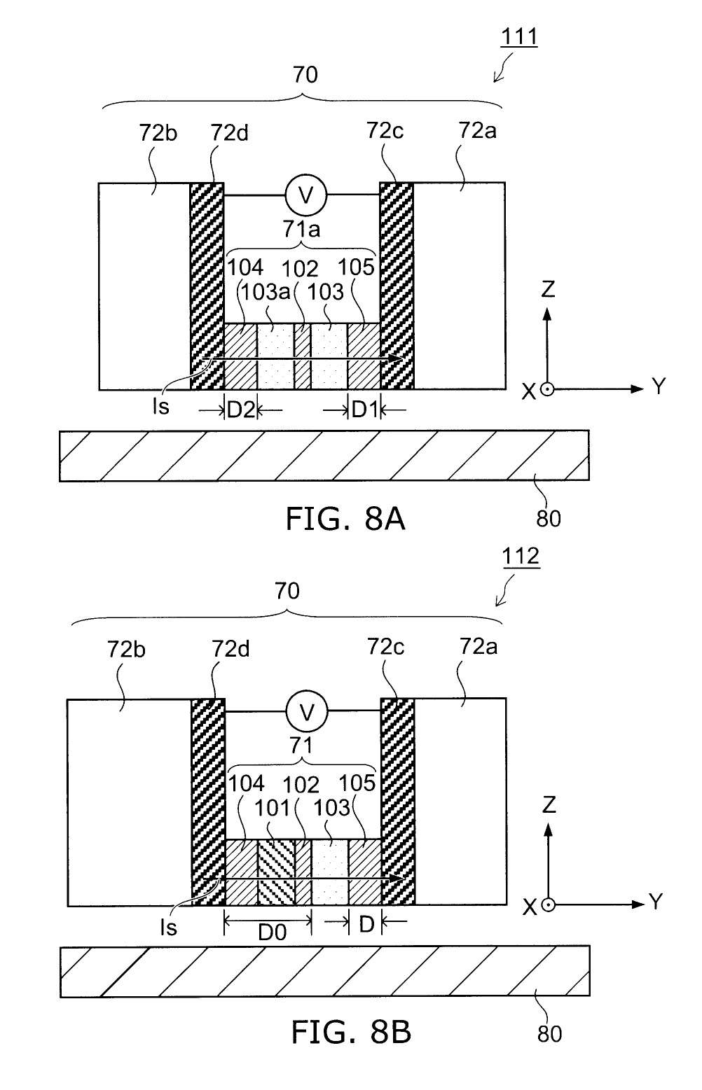

FIG. 8A is a schematic view illustrating the configuration of the magnetic head 111 according to the second embodiment.

More specifically, FIG. 8A shows the reproducing head section 70 of the magnetic head 111 opposed to a magnetic recording medium 80 as viewed in the cross section taken along the recording down track direction Y and the direction Z perpendicular to the medium surface.

The magnetic head 111 according to the second embodiment is configured so that the magnetoresistive effect film 71a in the reproducing head section 70 includes a first magnetization free layer 103, a second magnetization free layer 103a, and an intermediate layer 102.

More specifically, the magnetoresistive effect film 71a further includes a second magnetization free layer 103a provided between the first magnetization free layer 103 and the second magnetic shield 72b, and an intermediate layer 102 provided between the first magnetization free layer 103 and the second magnetization free layer 103a.

The structure composed of the first magnetization free layer 103, the second magnetization free layer 103a, and the intermediate layer 102 is provided with a cap layer 105 on one side, and a underlayer 104 on the other side. Furthermore, the magnetoresistive effect film 71a is provided with a first magnetic shield 72a on one side, and a second magnetic shield 72b on the other side.

The magnetic head 111 according to this embodiment includes a third magnetic shield 72c between the first magnetization free layer 103 of the magnetoresistive effect film 71a and the first magnetic shield 72a. The magnetic head 111 further includes a fourth magnetic shield 72d between the second magnetization free layer 103a and the second magnetic shield 72b.

In the magnetic head 111, the cap layer 105 is provided between the third magnetic shield 72c and the first magnetization free layer 103. In the magnetic head 111, the underlayer 104 is provided between the fourth magnetic shield 72d and the second magnetization free layer 103a.

As a result of such configuration, the spacing between the opposed surfaces of the first magnetization free layer 103 and the third magnetic shield 72c is set to D1, and the spacing between the opposed surfaces of the second magnetization free layer 103a and the fourth magnetic shield 72d is set to D2. The spacings D1 and D2 are preferably 10 nanometers (nm) or less as described with reference to FIG. 5. Each thickness of the third magnetic shield 72c and the fourth magnetic shield 72d is preferably 30 nanometers (nm) or less as shown in FIG. 7 and its description.

In the magnetic head 111 according to the second embodiment, magnetic noise due to spin transfer torque in the magnetization free layer 103 is suppressed by the third magnetic shield 72c provided in the magnetic head 111. Furthermore, magnetic noise due to spin transfer torque in the magnetization free layer 103a is suppressed by the fourth magnetic shield 72d provided in the magnetic head 111.

Thus, the magnetic head 111 achieves magnetic noise reduction in a magnetic recording/reproducing apparatus with high recording density. Thus, high-quality reproduced signals with high SN ratio are obtained.

FIG. 8B is a schematic view illustrating the configuration of the magnetic head 112 according to another example of the second embodiment.

More specifically, FIG. 8B shows the reproducing head section 70 of the magnetic head 112 opposed to a magnetic recording medium 80 as viewed in the cross section taken along the recording down track direction Y and the direction Z perpendicular to the medium surface.

The reproducing head section 70 includes a magnetoresistive effect film 71 including a first magnetization free layer 103, a first magnetic shield 72a located on one side of the magnetoresistive effect film 71, a second magnetic shield 72b located on the other side of the magnetoresistive effect film 71, and a third magnetic shield 72c located between the magnetoresistive effect film 71 and the first magnetic shield 72a.

The width (length along the direction X) of the magnetoresistive effect film 71 is comparable to or less than the recording track width. In the magnetoresistive effect film 71, a current (sense current Is) is passed in the perpendicular-to-plane direction of the magnetoresistive effect film 71 through the first magnetic shield 72a and the second magnetic shield 72b.

The magnetoresistive effect film 71 illustratively includes a underlayer 104, a magnetization pinned layer 101, an intermediate layer 102, a first magnetization free layer 103, and a cap layer 105. The magnetoresistive effect film 71 is stacked along the direction Y in the order of, e.g., the underlayer 104, magnetization pinned layer 101, intermediate layer 102, first magnetization free layer 103, and cap layer 105.

The magnetic head 112 according to this embodiment includes a third magnetic shield 72c between the first magnetization free layer 103 of the magnetoresistive effect film 71a and the first magnetic shield 72a. The magnetic head 112 further includes a fourth magnetic shield 72d between the magnetoresistive effect film 71 and the second magnetic shield 72b.

In the magnetic head 112 according to another example of the second embodiment, magnetic noise due to spin transfer torque in the magnetization free layer 103 is suppressed by the third magnetic shield 72c and the fourth magnetic shield 72d provided in the magnetic head 112.

Thus, the magnetic head 112 achieves magnetic noise reduction in a magnetic recording/reproducing apparatus with high recording density. Thus, high-quality reproduced signals with high SN ratio are obtained.

### THIRD EMBODIMENT

Next, a magnetic recording/reproducing apparatus and a magnetic head assembly according to a third embodiment are described. The magnetic head according to the embodiments described above can illustratively be incorporated in an integrated recording/reproducing magnetic head assembly, which can be installed on a magnetic recording/reproducing apparatus. Here, the magnetic recording/reproducing apparatus according to this embodiment can have only the reproducing function, or both the recording and reproducing function.

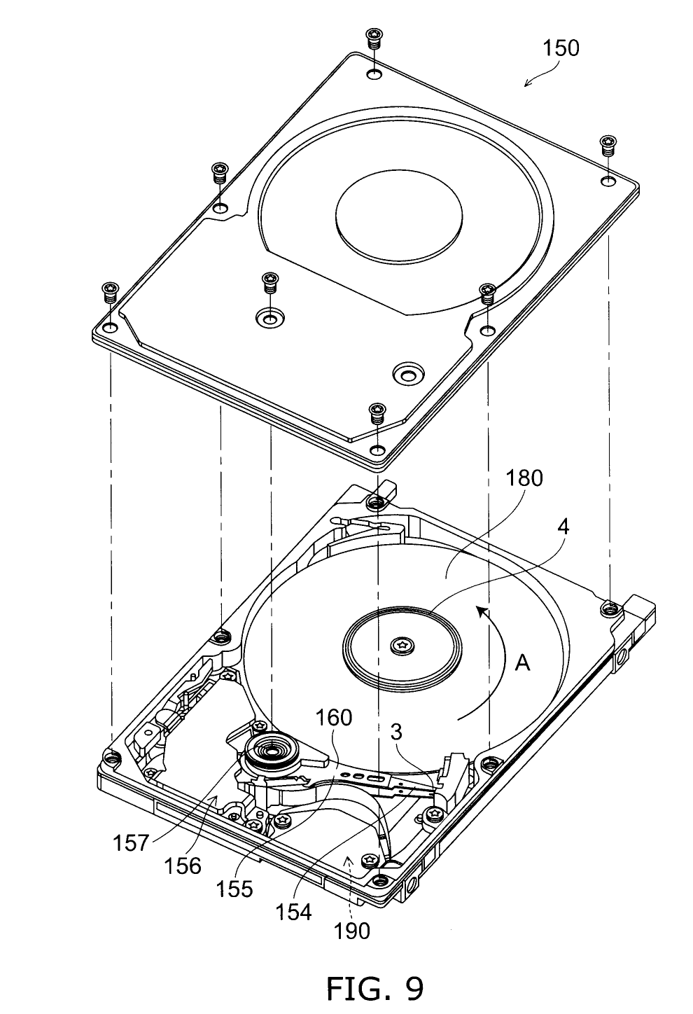

FIG. 9 is a schematic perspective view illustrating the configuration of the magnetic recording/reproducing apparatus according to the third embodiment.

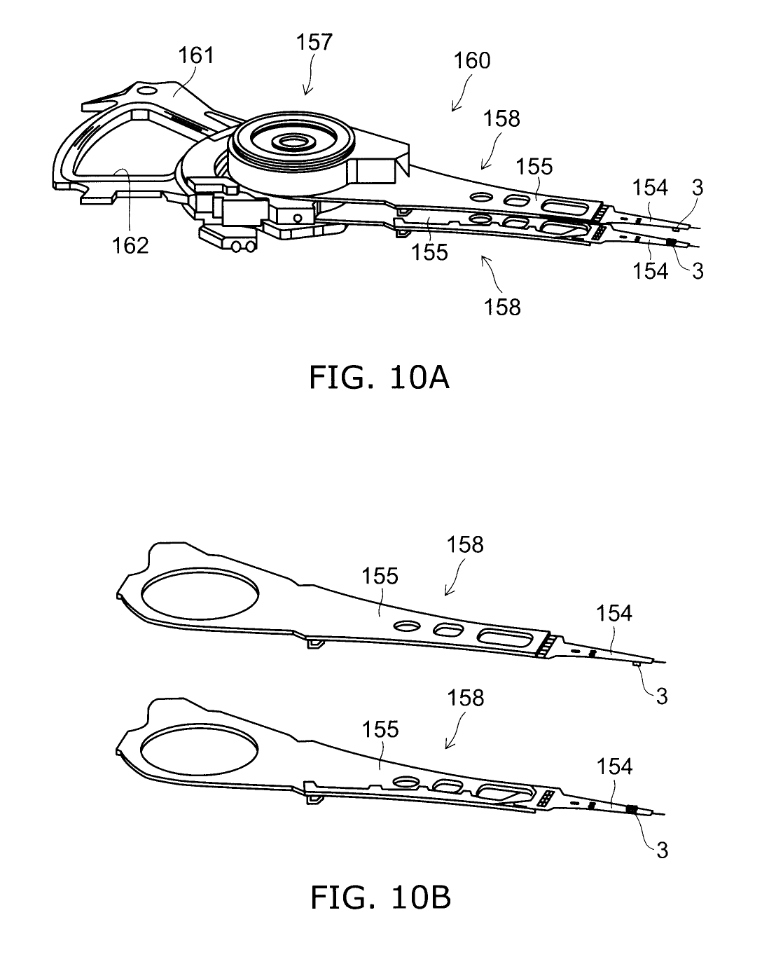

FIGS. 10A and 10B are schematic perspective views illustrating the configuration of part of the magnetic recording apparatus according to the third embodiment.

As shown in FIG. 9, the magnetic recording/reproducing apparatus 150 according to the third embodiment is an apparatus based on a rotary actuator. In this figure, a recording medium disk 180 is mounted on a spindle motor 4 and rotated in the direction of arrow A by a motor, not shown, in response to a control signal from a drive controller, not shown. The magnetic recording/reproducing apparatus 150 according to this embodiment may include a plurality of recording medium disks 180.

The head slider 3 for recording/reproducing information stored on the recording medium disk 180 has a configuration as described above, and is attached to the tip of a thin-film suspension 154. Here, on the head slider 3, for instance, one of the magnetic heads 110 and 111 according to the embodiments described above is installed near the tip of the head slider 3.

When the recording medium disk 180 is rotated, the pressing pressure by the suspension 154 is balanced with the pressure generated at the medium facing surface (air bearing surface, ABS) of the head slider 3. Thus, the medium facing surface of the head slider 3 is held at a prescribed floating amount from the surface of the recording medium disk 180. Here, the head slider 3 may be of the so-called “contact-traveling type”, in which case the head slider 3 is in contact with the recording medium disk 180.

The suspension 154 is connected to one end of an actuator arm 155 including a bobbin for holding a driving coil, not shown. A voice coil motor 156, which is a kind of linear motor, is provided on the other end of the actuator arm 155. The voice coil motor 156 can include the driving coil, not shown, wound up around the bobbin of the actuator arm 155, and a magnetic circuit composed of a permanent magnet and an opposed yoke opposed across this coil.

The actuator arm 155 is held by ball bearings, not shown, provided at two positions, top and bottom, of a bearing portion 157, so that the actuator arm 155 can be slidably rotated by the voice coil motor 156. Consequently, the magnetic recording head can be moved to an arbitrary position on the recording medium disk 180.

FIG. 10A illustrates the configuration of part of the magnetic recording/reproducing apparatus according to this embodiment, and is an enlarged perspective view of a head stack assembly 160.

FIG. 10B is a perspective view illustrating a magnetic head assembly (head gimbal assembly) 158, which constitutes part of the head stack assembly 160.

As shown in FIG. 10A, the head stack assembly 160 includes a bearing portion 157, a head gimbal assembly (HGA) 158 extending from this bearing portion 157, and a support frame 161 extending from the bearing portion 157 to the direction opposite from the HGA and supporting the coil 162 of the voice coil motor.

As shown in FIG. 10B, the head gimbal assembly 158 includes an actuator arm 155 extending from the bearing portion 157, and a suspension 154 extending from the actuator arm 155.

A head slider 3 is attached to the tip of the suspension 154. On the head slider 3, one of the magnetic heads 110 and 111 according to the above embodiments is installed.

Thus, the magnetic head assembly (head gimbal assembly) 158 according to this embodiment includes the magnetic head according to the above embodiments, a head slider 3 with the magnetic head installed thereon, a suspension 154 with the head slider 3 installed on one end, and an actuator arm 155 connected to the other end of the suspension 154.

The suspension 154 includes lead wires (not shown) for writing and reading signals, for a heater for adjusting the floating amount, and for the spin torque oscillator. These lead wires are electrically connected to respective electrodes of the magnetic head incorporated in the head slider 3.

Furthermore, a signal processing unit 190 is configured to write and read signals on the magnetic recording medium using the magnetic recording head. For instance, the signal processing unit 190 is provided on the rear surface side, as viewed in FIG. 9, of the magnetic recording/reproducing apparatus 150 illustrated in FIG. 9. The input/output lines of the signal processing unit 190 are connected to the electrode pads of the head gimbal assembly 158 and electrically coupled to the magnetic recording head.

Thus, the magnetic recording/reproducing apparatus 150 according to this embodiment includes a magnetic recording medium, the magnetic head according to the above embodiments, a movable unit capable of relatively moving the magnetic recording medium and the magnetic head in a spaced or contact state, a position control unit for positioning the magnetic recording head at a prescribed recording position on the magnetic recording medium, and a signal processing unit for writing and reading signals on the magnetic recording medium using the magnetic recording head.

More specifically, the aforementioned magnetic recording medium can be a recording medium disk 180. The aforementioned movable unit can include a head slider 3.

The aforementioned signal processing unit can include a head gimbal assembly 158.

In other words, the magnetic recording/reproducing apparatus 150 according to this embodiment includes a magnetic recording medium, the magnetic head assembly according to this embodiment, and a signal processing unit for writing and reading signals on the magnetic recording medium using the magnetic head installed on the magnetic head assembly.

In the magnetic recording/reproducing apparatus 150 according to this embodiment, by using the magnetic head according to the above embodiments, magnetic noise due to spin transfer torque is suppressed. Thus, high-quality reproduced signals with high SN ratio are obtained.

Here, in the above description, the magnetic head 110 or 111 is illustratively applied to the magnetic recording/reproducing apparatus 150. However, the magnetic heads 110 and 111 are also applicable to a magnetic reproducing apparatus.

The embodiments of the invention have been described with reference to examples. However, the invention is not limited to these examples. For instance, any specific configuration of each component included in the magnetic head, magnetic head assembly, and magnetic recording apparatus is encompassed within the scope of the invention as long as those skilled in the art can similarly practice the invention and achieve similar effects by suitably selecting such configuration from conventionally known ones.

Furthermore, any two or more components of the examples can be combined with each other as long as technically feasible, and those skilled in the art can suitably modify and implement the magnetic recording head, magnetic head assembly, and magnetic recording apparatus. All such combinations and modifications are also encompassed within the scope of the invention as long as they fall within the spirit of the invention.

Furthermore, those skilled in the art can suitably modify and implement the magnetic recording head, magnetic head assembly, and magnetic recording/reproducing apparatus described above in the embodiments of the invention. All the magnetic recording heads, magnetic head assemblies, and magnetic recording/reproducing apparatuses thus modified are also encompassed within the scope of the invention as long as they fall within the spirit of the invention.

Furthermore, those skilled in the art can conceive various modifications and variations within the spirit of the invention. It is understood that such modifications and variations are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

1. A magnetic head comprising: a reproducing section,
the reproducing section including:
a first magnetic shield;
a second magnetic shield;
a magnetoresistive effect film provided between the first magnetic shield and the second magnetic shield and including a first magnetization free layer changing a magnetization direction in response to an external magnetic field; and
a third magnetic shield provided between the magnetoresistive effect film and the first magnetic shield and having a higher saturation magnetic flux density than the first magnetic shield.

2. The magnetic head according to claim 1, wherein distance between the first magnetization free layer and the third magnetic shield is narrower than distance between the first magnetization free layer and the second magnetic shield.

3. The magnetic head according to claim 1, wherein the reproducing section further includes:
a fourth magnetic shield provided between the magnetoresistive effect film and the second magnetic shield and having a higher saturation magnetic flux density than the second magnetic shield.

4. The magnetic head according to claim 1, wherein the magnetoresistive effect film further includes:
a magnetization pinned layer provided between the first magnetization free layer and the second magnetic shield; and
an intermediate layer provided between the magnetization pinned layer and the first magnetization free layer.

5. The magnetic head according to claim 1, wherein the magnetoresistive effect film further includes:
a second magnetization free layer provided between the first magnetization free layer and the second magnetic shield; and
an intermediate layer provided between the first magnetization free layer and the second magnetization free layer.

6. The magnetic head according to claim 3, wherein the magnetoresistive effect film further includes:
a second magnetization free layer provided between the first magnetization free layer and the second magnetic shield; and
an intermediate layer provided between the first magnetization free layer and the second magnetization free layer.

7. The magnetic head according to claim 1, wherein spacing between a surface of the third magnetic shield facing the first magnetization free layer and a surface of the first magnetization free layer facing the third magnetic shield is 10 nanometers or less.

8. The magnetic head according to claim 6, wherein spacing between a surface of the fourth magnetic shield facing the second magnetization free layer and a surface of the second magnetization free layer facing the fourth magnetic shield is 10 nanometers or less.

9. The magnetic head according to claim 1, wherein the third magnetic shield includes one of Fe, Co, an alloy of Fe, and an alloy of Co.

10. The magnetic head according to claim 9, wherein the third magnetic shield is added with a non-magnetic element.

11. The magnetic head according to claim 1, wherein the first magnetic shield and the second magnetic shield include a NiFe alloy.

12. The magnetic head according to claim 1, wherein a thickness of the third magnetic shield along a direction to the first magnetization free layer is 30 nanometers or less.

13. The magnetic head according to claim 5, wherein a thickness of the fourth magnetic shield along a direction to the second magnetization free layer is 30 nanometers or less.

14. The magnetic head according to claim 1, wherein the surface of the third magnetic shield facing the first magnetization free layer has a larger size than the surface of the first magnetization free layer facing the third magnetic shield.

15. The magnetic head according to claim 1, wherein one side of a current-flow cross section of the first magnetization free layer has a length of 50 nanometers or less in the case where the current-flow cross section is shaped like a square.

16. The magnetic head according to claim 4, wherein the magnetoresistive effect film includes:
a underlayer provided between the second magnetic shield and the magnetization pinned layer.

17. The magnetic head according to claim 4, wherein the magnetoresistive effect film includes:
a cap layer provided between the first magnetization free layer and the third magnetic shield.

18. The magnetic head according to claim 3, wherein the magnetoresistive effect film further includes:
a magnetization pinned layer provided between the first magnetization free layer and the second magnetic shield; and
an intermediate layer provided between the magnetization pinned layer and the first magnetization free layer.

19. A magnetic head assembly comprising:
a suspension configured to install the magnetic head according to claim 1 on one end; and
an actuator arm connected to one other end of the suspension.

20. A magnetic recording/reproducing apparatus comprising:
the magnetic head assembly according to claim 19; and
a magnetic recording medium having information to be reproduced by using the magnetic head installed on the magnetic head assembly.
